(19) United States
(12) Patent Application Publication
(10) Pub. No.: US 2025/0368488 A1
(43) Pub. Date: Dec. 4, 2025

(54) ARRANGEMENT FOR A MOBILE ROBOT

(71) Applicant: ROEQ APS, Vissenbjerg (DK)

(72) Inventor: Michael EJSTRUP HANSEN, MORUD (DK)

(21) Appl. No.: 18/875,134

(22) PCT Filed: Jun. 15, 2023
(86) PCT No.: PCT/EP2023/066072

§ 371 Date: Dec. 14, 2024

(30) Foreign Application Priority Data
Jun. 15, 2022 (DK) PA 2022 00575

(51) Int. Cl. B66F 9/19; B65G 13/00; B66F 9/06

(52) U.S. Cl. CPC B66F 9/19; B65G 13/00; B66F 9/063

(57) ABSTRACT

An arrangement (20) for a mobile robot (10) is provided. The arrangement forms an interface for a pallet (100) to be loaded and unloaded from the mobile robot (10). The arrangement comprises a sliding mechanism (40) that forms a sliding interface for an associated pallet (100) and a fixed surface (50) that forms a stationary interface for the associated pallet (100). The sliding mechanism (40) and the fixed surface (50) define respective first and second vertical levels (L1, L2), wherein at least one vertical level (L1, L2) is adjustable to an extent allowing an associated pallet (100) to be loaded and/or unloaded from an associated pallet rack (110).

### TECHNICAL FIELD

The present invention relates to an arrangement for a mobile robot. In particular, the present invention relates to an arrangement for improving the loading/unloading operation of pallets to and from mobile robots.

### BACKGROUND

Mobile robots are used in various applications for providing automatic transport of articles. While the motion from the loading/unloading stations is normally fully automatic and pre-programmed, there have been made attempts to also make the loading/unloading operation faster and less intense in terms of manual labor. In inventories and production sites, pallets are typically used for storing articles and the mobile robots used in such environments must be configured for proper pallet handling.

As of today there are mainly two types of pallet handling systems. A first type of system makes use of a lift to load/unload pallets to and from a pallet rack. A second type of system makes use of a conveyor to load/unload pallets to and from a conveying station. There is often a desire to combine these two systems such that a pallet can be unloaded from a pallet rack at the inventory, and deliver the pallet to a conveyor at the production facility.

Until now such transport needs dedicated receiving stations with rollers for moving the pallet from the mobile robot to the conveyor. One problem with such added stations is that they occupy a significant amount of space.

Hence, there is no versatile solution for pallet handling by mobile robots. In one known solution the upper surface of the mobile robot is provided with rollers such that the pallet can slide on and off the mobile robot. As it is of great importance that the pallet stays on the mobile robot during transport, the rollers must be equipped with a suitable, and robust, brake mechanism in order to prevent unintentional movement of the pallet relative the mobile robot.

While the above solution is a pragmatic solution for allowing pallets to be loaded and unloaded to the mobile robot, it would be beneficial to seek for an alternative solution for the roller brake mechanism while still providing the required fixation of the pallet during transport. Further, it would be desirable to provide a solution for mobile robots which reduces the need for additional pallet handling stations.

### SUMMARY

It is an object of the present invention to wholly or partly overcome the above disadvantages and drawbacks of the prior art. More specifically, it is an object to provide an arrangement for a mobile robot which allows the pallet to slide on and off the mobile robot, but with no need for a dedicated brake mechanism acting on any associated rollers. Further, it is an object to provide an arrangement for a mobile robot allowing for versatile use of the mobile robot.

According to a first aspect an arrangement for a mobile robot is provided. The arrangement forms an interface for a pallet to be loaded and unloaded from the mobile robot, wherein said arrangement comprises a sliding mechanism that forms a sliding interface for an associated pallet and a fixed surface that forms a stationary interface for the associated pallet. The sliding mechanism and the fixed surface define respective first and second vertical levels, and at least one vertical level is adjustable to an extent allowing an associated pallet to be loaded and/or unloaded from an associated pallet rack.

An arrangement for a mobile is provided which allows for efficient transport of pallets. The arrangement forms an interface for a pallet to be loaded and unloaded from the mobile robot, wherein said arrangement comprises a sliding mechanism that forms a sliding interface for an associated pallet and a fixed surface that forms a stationary interface for the associated pallet. The arrangement is selectively configured in a first mode, allowing a pallet to slide on and off the arrangement by means of the sliding mechanism, a second mode, allowing a pallet to be stationary on the arrangement by resting on the fixed surface, and a third mode, allowing a pallet to be loaded on and off a pallet rack. Preferably, the pallet is arranged at three different vertical levels in the first, second, and third mode respectively by adjusting the vertical level of the sliding mechanism and/or the fixed surface.

The arrangement may further comprise a control unit configured to selectively cause at least one of the sliding mechanism and the fixed surface to be arranged in an active position in which it is intended to be engaged with a loaded pallet. Automatic control of the arrangement is thereby achieved for improved operation of the arrangement and the associated mobile robot during loading and unloading of pallets.

The control unit may be configured to cause one of the sliding mechanism and the fixed surface to be arranged in the active position by vertically moving the sliding mechanism or the fixed surface. This allows the arrangement to have a fixed horizontal configuration, as control between a sliding interface and a stationary interface is effected by a pure vertical motion.

The arrangement may further comprise a lifting mechanism being configured to vertically move the sliding mechanism or the fixed surface.

The inventor has surprisingly realized that by combining a sliding interface with a pallet lifting mechanism it is possible to arrange the mobile robot in either one of sliding configuration, when the pallet is allowed to slide on and off the mobile robot, and a stationary configuration, which can be used during transport of the mobile robot and the loaded pallet. The pallet lifting mechanism further allows the mobile robot to position itself under the pallet when stored on a pallet rack, and to lift the pallet for unloading it from the pallet rack. Hence, the combination of a sliding mechanism and a pallet lifting mechanism effectively reduces the need for dedicated loading and unloading stations, which are otherwise required for changing the interface between stationary positioning of pallets (i.e. pallet racks) and moving stations (i.e. conveyors and the like).

The arrangement may comprise a base level surface and at least one elongated bar vertically displaced from the base level surface, wherein the base level surface and the at least one elongated bar comprises a respective one of the sliding mechanism and the fixed surface. The arrangement is thus configured with distinct sections for the sliding mechanism and for the fixed surface.

The base level surface may comprise the sliding mechanism, and the at least one elongated bar may comprise the fixed surface, and wherein the at least one elongated bar is vertically moveable between a lowered inactive position, in which an associated pallet is engaged with the sliding mechanism at the first vertical level, and a raised active position, in which an associated pallet is engaged with the fixed surface at the second vertical level.

Optionally, the base level surface may comprise the fixed surface, and the at least one elongated bar may comprise the sliding mechanism, and wherein the at least one elongated bar is vertically moveable between a lowered inactive position, in which an associated pallet is engaged with the fixed surface at the first vertical level, and a raised active position, in which an associated pallet is engaged with the sliding mechanism at the second vertical level.

The sliding mechanism may comprise a drive unit for actively driving an associated pallet along the arrangement. Hence an “active” sliding mechanism is provided which will selectively be in a driving/sliding configuration and a stationary configuration.

According to a second aspect, a mobile robot is provided. The mobile robot comprises an arrangement according to the first aspect. The arrangement may either be integrated with the mobile robot, or it may be provided as a separate top module to be mounted to an existing mobile robot.

### BRIEF DESCRIPTION ON THE DRAWINGS

The invention and its many advantages will be described in more detail below with reference to the accompanying schematic drawings, which for the purpose of illustration show some non-limiting embodiments and in which

FIG. 1a is a schematic view of a prior art mobile robot interacting with a fixed pallet loading station;

FIG. 1b is a schematic view of a prior art mobile robot interacting with a conveying pallet loading station;

FIGS. 2a-h are schematic views of a mobile robot comprising an arrangement according to an embodiment;

FIGS. 3a-h are schematic views of a mobile robot comprising an arrangement according to another embodiment;

FIGS. 4a-d are schematic views of a mobile robot comprising an arrangement according to a further embodiment; and

FIG. 5 is a side view of a mobile robot comprising an arrangement according to an embodiment.

### DETAILED DESCRIPTION

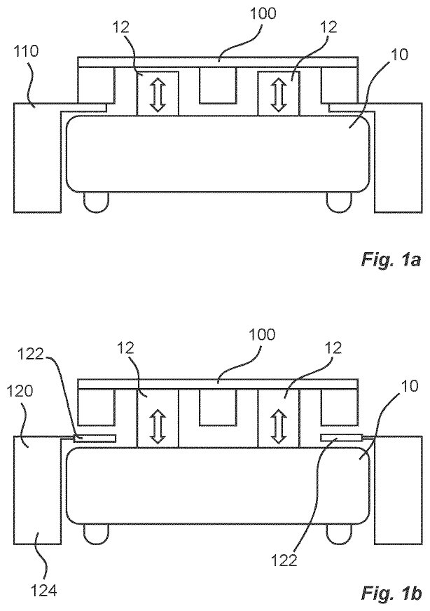

Starting in FIG. 1a a generic embodiment of a prior art mobile robot 10 is schematically shown during typical operation. The mobile robot 10 is programmed to load, transport, and unload pallets 100 of various types and configurations. For example, the pallets 100 may be so called Euro pallets, stringer pallets, etc.

In order to illustrate the function of the mobile robot 10 the pallet 100 is to be picked up from a first station 110 in the form of a pallet rack. The pallet 100 may be loaded with goods or articles (not shown) which are to be transported by the mobile robot 10.

For pick up operation the mobile robot 10 is positioned underneath the pallet 100, as the pallet rack 110 forms an available space for the mobile robot 10 to occupy during loading.

The mobile robot 10 is provided with vertically moveable bars 12 which are initially arranged in a lowered position as indicated in Fig. la. The bars 12, when arranged in this lowered position, are able to be arranged below the pallet 100 when stored on the pallet rack 110.

When the mobile robot 10 is correctly positioned below the pallet 100 the bars 12 are controlled to be raised such that they engage with the underside of the pallet 100 and subsequently raises the pallet 100 from the pallet rack 110. By this, the mobile robot 10 can start moving thereby also transporting the pallet 100 away from the pallet rack 110 towards its intended destination.

The unloading operation, or drop off, of the prior art mobile robot 10 is schematically shown in FIG. 1b. In this figure the bars 12 are arranged in their raised position and the mobile robot 10 has positioned itself at the area of a second station 120 in the form of a conveying rack. This conveying rack 120, which normally forms an intermediate station being connected to further conveying equipment, is typically required for allowing the mobile robot 10 to unload the pallet to a conveyor equipment. The conveying rack 120 has pairs of horizontal rollers 122 supported by a frame 122, wherein the rollers 122 are vertically arranged such that the mobile robot 10 may drive underneath the rollers 122 while the pallet 10 is arranged above the rollers 122. When the mobile robot 10 is aligned with the conveying rack 120 the bars 12 are lowered such that the pallet 100 rests on the rollers 122. The mobile robot 10 can then leave the conveying rack 120 which transports the pallet 100 to further equipment.

Once the pallet 100 is loaded to the mobile robot 10, the mobile robot 10 is securing the position of the pallet 100 by means of the bars 12 such that safe transportation of the pallet 100 is ensured. The mobile robot 10, including the loaded pallet 100, drives automatically from the first station 110 to the second station 120, i.e. the unloading station. It should be noted that the reverse process is equally possible, i.e. the mobile robot 10 picks up the pallet 100 from the conveying rack 120 and drops it off at the pallet rack 110.

Prior art mobile robots have not been capable of interacting with both fixed pallet racks 110 and conveying equipment without the need for the above-described conveying rack 120; for prior art mobile robots 10 either the first and second stations 110, 120 must be similarly designed (i.e. either conveyor type or stationary rack type) in accordance with the particular configuration of the mobile robot, or dedicated equipment (such as the conveying rack 120) must be added to match the configuration of the mobile robot.

The mobile robots 10 described within this specification all share the common feature of being provided with an arrangement 20. As will be further explained in the following the arrangement forms an interface for a pallet 100 to be loaded and unloaded from the mobile robot 10. The arrangement 20 comprises a sliding mechanism 40 that forms a sliding interface for an associated pallet 100 and a fixed surface 50 that forms a stationary interface for the associated pallet. By switching the active pallet interface from the sliding mechanism 40 to the fixed surface 50, the sliding mechanism 40 does not need brakes. Also, by switching the support surface from the fixed surface 50 to the sliding mechanism 40, there is no longer a need for additional conveying racks 120 as the pallet 100 can be unloaded directly onto conveying equipment.

The arrangement 20 can be built-in the mobile robot 10 such that the mobile robot 10 and the arrangement 20 form an integral unit. Optionally the arrangement 20 is produced to form part of a top module being produced separately from the mobile robot 10, but which can be added to existing mobile robots 10 in order to add functionality to such mobile robots 10.

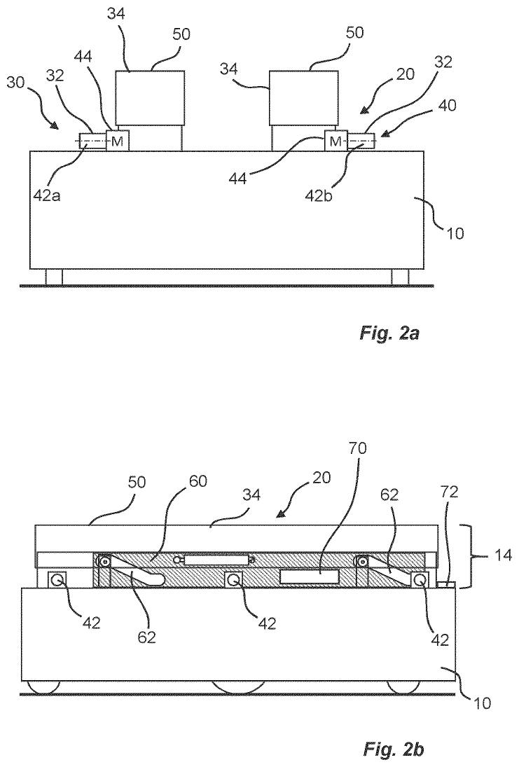

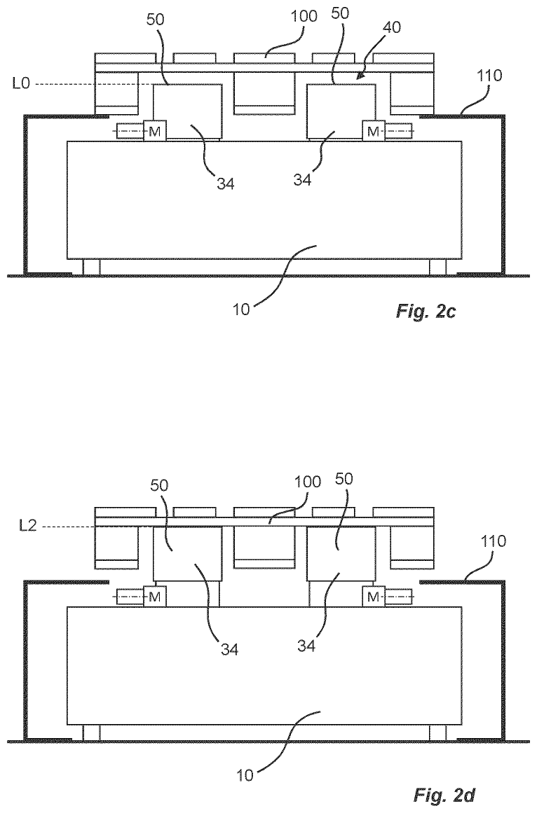

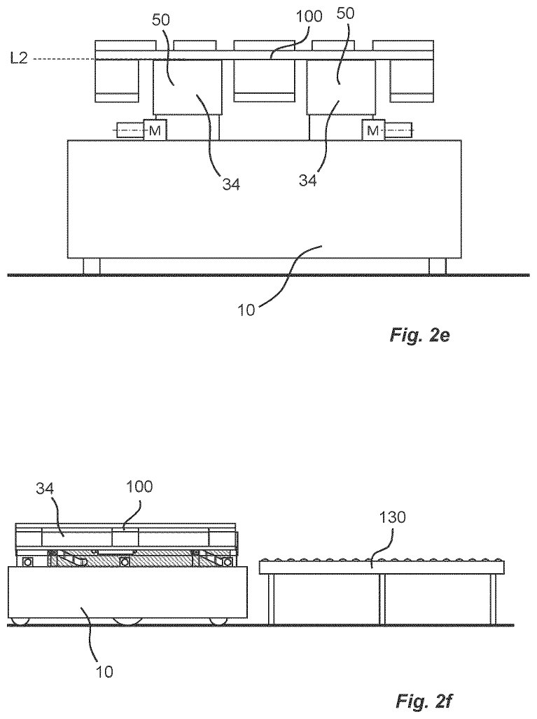

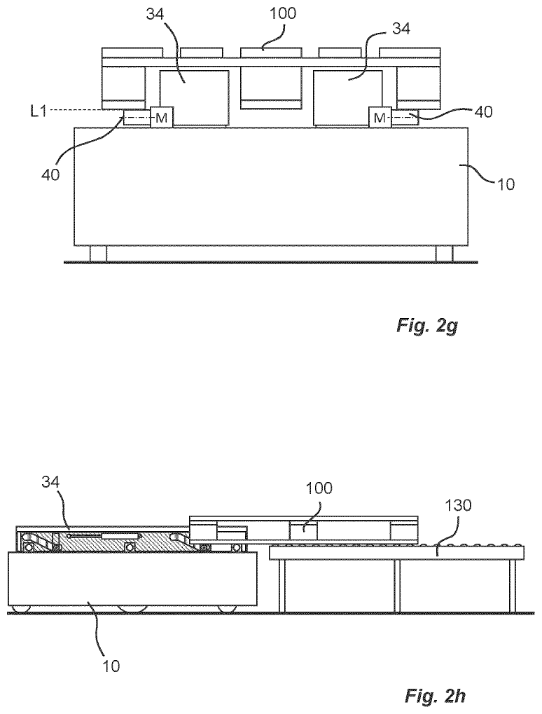

Now turning to FIGS. 2a-h a mobile robot 10 will be described. The mobile robot 10 is provided with an arrangement 20 according to a first embodiment. The as arrangement 20 forms an area of the mobile robot facing vertically upwards, i.e. towards the underside of the associated pallet 100 when the pallet 100 is loaded onto the mobile robot 10. The arrangement 20 comprises a base level surface 32 and at least one elongated bar 34 vertically displaced from the base level surface 32. In the shown example there are two parallel bars 34 to fit with existing Euro pallets.

Each one of the base level surface 32 and the elongated bar(s) 34 comprises a respective one of the sliding mechanism 40 and the fixed surface 50. Hence, the base level surface 32 is thus not necessarily defined as the lowermost surface of the arrangement 20 but only as a surface 32 at a specific vertical level and comprising either the sliding mechanism 40 or the fixed surface 50.

In the shown embodiment the arrangement 20 comprises two parallel elongated bars 34. These bars 34 are dimensioned to fit with certain pallets 100, especially to fit with cavities normally provided for allowing access by forks or other lifting means. The bars 34 are configured to match the associated pallet 100, and due to the provision of different types of pallets 100 on the market the exact number and dimensions of the at least one elongated bar 34 may vary accordingly.

The at least one bar 34 may, or may not, extend along the entire length of the arrangement 20 of the mobile robot 10.

In this particular embodiment the sliding mechanism 40 is forming part of the base level surface 32. In the shown example the sliding mechanism 40 comprises a plurality of pairs of rollers 42. The rollers 42 are preferably arranged in a common horizontal plane and having a rotational axis oriented perpendicular to the longitudinal extension of the bar(s) 34. Hence, a pallet 100 arranged on the rollers 42 will be allowed to slide in the same direction as the longitudinal extension of the bar(s) 34.

Each pair of rollers 42 comprises a first roller 42a arranged close to one side of the mobile robot 10, and a second roller 42b arranged close to an opposite side of the mobile robot 10. The rollers 42a-b are preferably arranged outwards the bar(s) 34, i.e. between the bar 34 and the lateral edge of the mobile robot 10.

As can be seen in FIG. 2b there are three pairs of rollers 42 spaced apart by an equal distance along the longitudinal extension of the mobile robot 10. However, any number of pairs of rollers 42 may be considered as long as they provide the required support for an associated pallet 100.

One or more of the rollers 42 may be driven, e.g. by an electric motor 44 (se FIG. 2a). This allows for automatic loading and unloading of pallets 100 to and from associated conveying equipment. Further, such motor drive also provides a level of security as non-rotation of the driven roller 42 will in practice provide a brake function for the sliding mechanism 40.

The drive mechanism for the rollers 42, i.e. the electric motor 44 and suitable transmission components, may in some embodiments be embedded inside one of the elongated bars 34.

In the shown example the fixed surface 50 is defined as the uppermost surface of the bar(s) 34. The fixed surface 50 is preferably planar and horizontal, and provides a certain friction against the pallet 100 such that the pallet 100 stays in position when supported by the fixed surface 50 even when the mobile robot 10 is moving. It should however be noted that the fixed surface 50 may be further provided with structural features for improving the connection to the pallet 100.

As can be seen in FIG. 2b the fixed surface 50 is vertically moveable. For this, a lifting mechanism 60 is provided. The lifting mechanism 60 may be designed in various ways, e.g. as in the shown example where tilted tracks 62 are used to convert a horizontal driving motion to a vertical movement of the bar(s) 34. For this up-and-down movement a suitable actuator (not shown) may be provided. As lifting mechanisms 60 for mobile robots 10 are commercially available, no further description of this mechanism and functionality will be further described herein. However it should be noted that in preferred embodiments the entire lifting mechanism 60 is embedded inside one of the elongated bars 34. A single lifting mechanism 60 is preferably provided for operating all elongated bars 34 simultaneously, and in synchronization. Combined with the embodiment described above, a mobile robot 10 having an arrangement 20 with two elongated bars 34 can thus be configured such that one elongated bar 34 encloses the lifting mechanism 60 for causing the vertical movement of the elongated bars 34, while the other elongated bar 34 encloses the drive mechanism for the rollers 42 of the sliding mechanism 40.

As is shown in FIG. 2b the mobile robot 10 is provided with a top module 14. This top module 14 is preferably produced as a separate unit and configured to be connectable to existing mobile robots 10, preferably both mechanically and electrically. The top module 14 is constructed to comprise the entire arrangement 20, i.e. the sliding mechanism 40, the fixed surface 50, the bar(s) 34, the lifting mechanism 60 as well as suitable control means for proper operation of the arrangement 20.

The arrangement 20 further comprises a control unit 70. The control unit 70 is configured to selectively cause at least one of the sliding mechanism 40 and the fixed surface 50 to be arranged in an active position in which it is intended to be engaged with a loaded pallet 100. The active position is achieved by vertically moving the sliding mechanism 40 or the fixed surface 50. In the embodiment shown in FIGS. 2a-h, the active position of the fixed surface 50 is obtained by vertically moving the elongated bars 34 upwards so that they engage with the pallet. The active position of the sliding mechanism 40 is obtained by lowering the elongated bars 34 so that the pallet 100 rests on the rollers 42.

The arrangement 20 may further comprise one or more sensors 72. The sensor(s) 72 is configured to monitor the position of an associated pallet 100 being loaded onto the arrangement 20. The sensor(s) 72 is preferably connected to the control unit 70 which also may be configured to control operation of the electrical motor 44. Hence, the sensor 72 can be used to monitor the current position of the pallet 100, and to drive the motor such that the pallet 100 is moved to a proper position onto the mobile robot 10. The sensor(s) 72 can further be used to monitor proper unloading of a pallet 100 by detecting when a pallet 100 is no longer arranged onto the mobile robot 10.

Now turning to FIGS. 2c-h operation of the mobile robot 10 will be explained. Starting in FIG. 2c a pallet 100 is stored on a pallet rack 110. The mobile robot 10 is positioned below the pallet 100 for transporting the pallet 100 away from the pallet rack 110. In this position, the fixed surface 50 of the arrangement 20 is arranged in a lowered position, defined as a vertical base level L0.

For loading the pallet 100 to the mobile robot 10 the arrangement 20 is controlled to raise the fixed surface 50. The bars 34 will be extended vertically upwards until the fixed surface 50 engages with the pallet 100. After such engagement the bars 34 will be extended further upwards such that the pallet 100 is lifted from the pallet rack 110. This is shown in FIG. 2d. In this raised and active position, the fixed surface 50 is arranged at a second vertical level L2.

The mobile robot 10 departs from the pallet rack 110 and transports the pallet 100 towards its destination. During this movement of the mobile robot 10 the bars 34 are still in a raised position at the second vertical level L2, as indicated in FIG. 2e, in order to ensure that the pallet 100 is engaged by the fixed surface 50.

In FIG. 2f a situation is shown where the mobile robot 10 approaches the pallet destination, here shown in the form of conveying equipment 130.

When the mobile robot 10 is positioned next to the loading end of the conveying equipment 130 the bars 34 are lowered until the pallet 100 engages with the sliding mechanism 40 at a first vertical level L1. The bars 34 continue to withdraw downwards until the pallet 100 is completely disengaged from the fixed surface 50, as is shown in FIG. 2g.

Unloading of the pallet 100 to the conveying equipment 130 is thereafter started, preferably by activing the roller motor(s) 44 to automatically transport the pallet 100 from the mobile robot 10 to the conveying equipment 130. This is shown in FIG. 2h. Preferably, the horizontal surface level of the associated conveying equipment 130 corresponds to the first vertical level L1, such that smooth transfer of the pallet 100 is accomplished.

The above described operation may be reversed without requiring any further explanation.

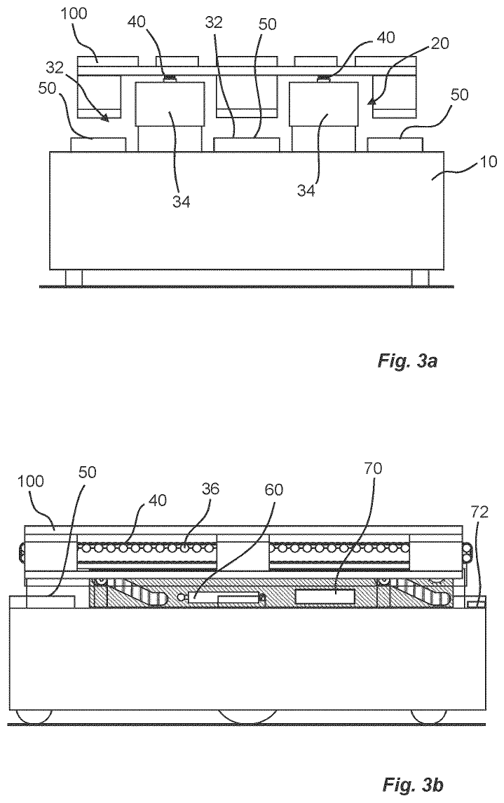

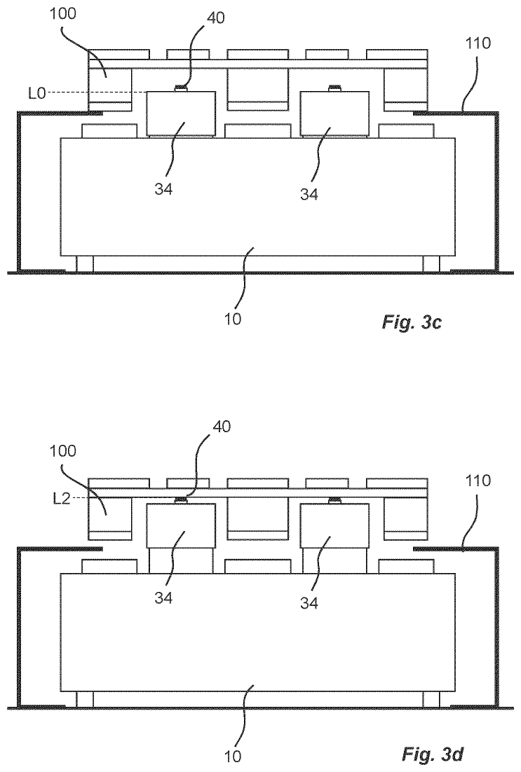

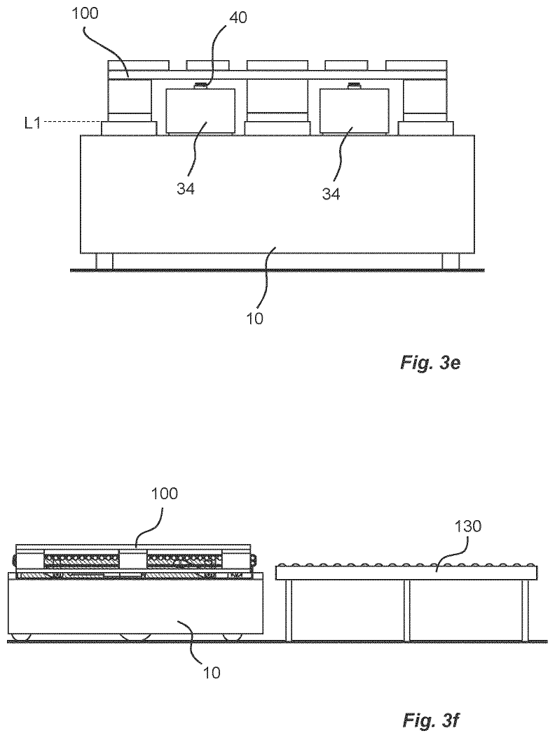

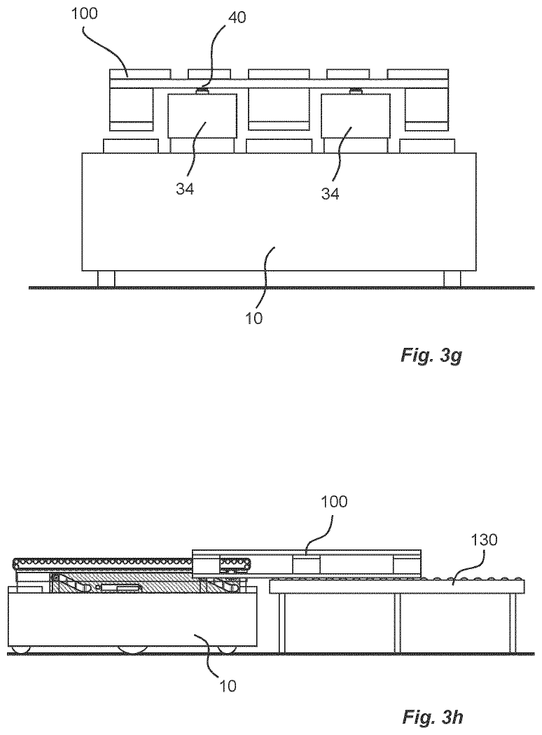

In FIGS. 3a-h another embodiment of an arrangement 20 for a mobile robot 10 is shown. The mobile robot 10 is provided with an arrangement 20 according to a second embodiment. The arrangement 20 comprises a base level surface 32 and at least one elongated bar 34 vertically displaced from the base level surface 32. In the shown example there are two parallel bars 34 to fit with existing Euro pallets.

As for the embodiment described with reference to FIGS. 2a-h, each one of the base level surface 32 and the elongated bar(s) 34 comprises a respective one of the sliding mechanism 40 and the fixed surface 50.

The sliding mechanism 40 is forming part of the elongated bar(s) 34. In the shown example each bar 34 is provided with rollers 36 forming the sliding mechanism 40. The rollers 36 are preferably arranged in a common horizontal plane at an upper part of the bar 34 and having a rotational axis oriented perpendicular to the longitudinal extension of the bar(s) 34. Hence, a pallet 100 arranged on the bars 34 and hence onto the rollers 36 will be allowed to slide in the same direction as the longitudinal extension of the bar(s) 34.

As can be seen in FIG. 3b each bar 34 is provided with a plurality of interconnecting rollers 36. The rollers 36 are preferably arranged in an endless belt, or at least along the extension of the bar 34. Any number of pairs of rollers 36 may be considered as long as they provide the required support for an associated pallet 100.

One or more of the rollers 36 may be driven, e.g. by an electric motor (not shown). Optionally, in case of an endless belt of rollers 36 the endless belt itself may be driven by an associated motor. This allows for automatic loading and unloading of pallets 100 to and from associated conveying equipment. Further, such motor drive also provides a level of security as non-rotation of the driven roller 36 will in practice provide a brake function for the sliding mechanism 40. As explained above, the required drive mechanism for the rollers 36 may be embedded inside one of the elongated bars 34.

In the shown example the fixed surface 50 is defined as a vertically lower surface of the arrangement 20. The fixed surface 50 is preferably planar and horizontal, and provides a certain friction against the pallet 100 such that the pallet 100 stays in position when supported by the fixed surface 50. It should however be noted that the fixed surface 50 may be further provided with structural features for improving the connection to the pallet 100.

The fixed surface 50 is vertically fixed, while the sliding mechanism 40 is vertically moveable. For this, a lifting mechanism 60 similar to the sliding mechanism 60 of FIGS. 2a-h may be provided.

Now turning to FIGS. 3c-h operation of the mobile robot 10 will be explained. Starting in FIG. 3c a pallet 100 is stored on a pallet rack 110. The mobile robot 10 is positioned below the pallet 100 for transporting the pallet 100 away from the pallet rack 110. In this position, the sliding mechanism 40 of the arrangement 20 is arranged in a lowered position corresponding to a vertical base level L0.

For loading the pallet 100 to the mobile robot 10 the arrangement 20 is controlled to raise the sliding mechanism 40. The bars 34 will be extended vertically upwards until the sliding mechanism 40 engages with the pallet 100. After such engagement the bars 34 will be extended further upwards such that the pallet 100 is lifted from the pallet rack 110. This is shown in FIG. 3d, i.e. the elongated bars 34 being arranged at a second vertical level L2 such that the pallet 100 is engaged with the sliding mechanism 40.

The mobile robot 10 departs from the pallet rack 110 and immediately lowers the bars 34 such that the pallet 100 engages with the fixed surface 50 at a first vertical level L1, as is shown in FIG. 3e. While the bars 34 are in this lowered position, the mobile robot 10 transports the pallet 100 towards its destination. Optionally the sliding mechanism 40 may be provided with some kind of brake mechanism allowing the bars 34 to be kept in their raised position during transport.

In FIG. 3f a situation is shown where the mobile robot 10 approaches the pallet destination, here shown in the form of conveying equipment 130. As indicated by FIG. 3f, the vertical position of the pallet 100 is below the vertical conveying level of the conveying equipment 130.

When the mobile robot 10 is positioned next to the loading end of the conveying equipment 130 the bars 34 are raised until the pallet 100 engages with the sliding mechanism 40. The bars 34 continue to lift until the pallet 100 is at the same vertical level as the conveying equipment 130, as is shown in FIG. 3g. Preferably, this vertical level corresponds to the second vertical level L2 indicated in FIG. 3d.

Unloading of the pallet 100 to the conveying equipment 130 is thereafter started, preferably by activing the sliding mechanism 40 to automatically transport the pallet 100 from the mobile robot 10 to the conveying equipment 130. This is shown in FIG. 3h.

The above described operation may be reversed without requiring any further explanation.

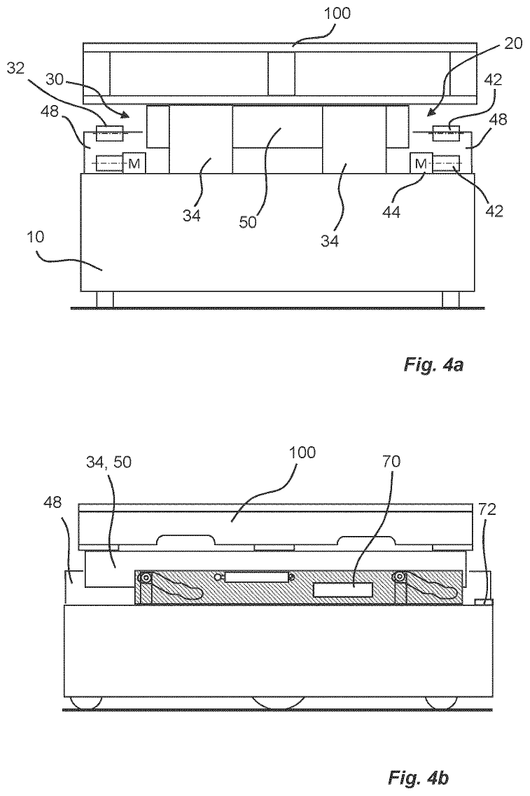

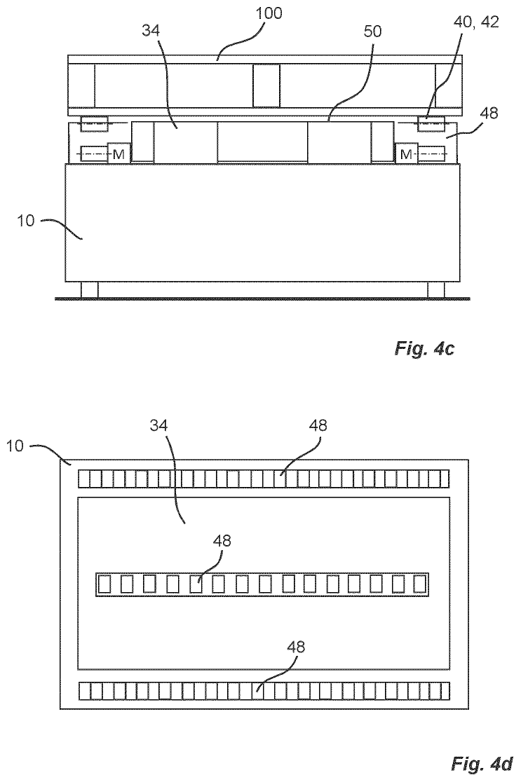

In FIGS. 4a-d a further embodiment of an arrangement 20 is shown. This arrangement 20 is designed to fit with other types of pallets 100 than previously described, especially pallets 100 not exhibiting the passages for receiving bars. For illustrative purposes, the pallet 100 is shown to have a continuous underside not allowing any bars 34 to be raised into matching recesses.

The embodiment of FIGS. 4a-d is similar to the embodiment of FIGS. 2a-h, except for two major differences; i) the two bars 34 are interconnected to form a single main fixed surface 50, and ii) the sliding mechanism 40 is modified to allow for a continuous underside of the pallet 100 to rest on it.

The sliding surface 40 is formed by two or more roller units 48, each roller unit 48 being arranged at a respective lateral end of the mobile robot 100. Optionally, as shown in

FIG. 4d, a central roller unit 48 may be arranged in between the two laterally arranged roller units 48. Hence, the fixed surface 50 of the bar(s) 34 is arranged in between the two laterally arranged roller units 48, possibly with a recess in which a central roller unit 48 may fit.

Each roller unit 48 comprises a plurality of rollers 42 in a similar configuration as described for the rollers 36 of the embodiment shown in FIGS. 3a-h. The rollers 42 are thus preferably arranged in an endless belt, or at least along the longitudinal extension of the mobile robot 10. Any number of rollers 42 may be considered as long as they provide the required support for an associated pallet 100.

One or more of the rollers 42 may be driven, e.g. by an electric motor 44. Optionally, in case of an endless belt of rollers 42 the endless belt itself may be driven by an associated motor 44. This allows for automatic loading and unloading of pallets 100 to and from associated conveying equipment. Further, such motor drive also provides a level of security as non-rotation of the driven roller 42 will in practice provide a brake function for the sliding mechanism 40.

In FIG. 4b a side view of the mobile robot 10 is shown, where it is clear that the pallet 100 is loaded on the fixed surface 50 being positioned vertically above the vertical upper end of the sliding mechanism 40.

A different configuration is shown in FIG. 4c, where the bar(s) 34 is lowered so that i) the pallet 100 is resting on the sliding mechanism 40, and ii) the fixed surface 50 is no longer in engagement with the pallet 100.

Operation of the arrangement 20 shown in FIGS. 4a-c is similar to the operation of the arrangement shown in FIGS. 2a-h.

While rollers have been mentioned to provide the sliding function of the sliding mechanism 40, it should be noted that other components could be used for achieving the same effect. For example, rollers could be replaced by balls or low friction sliding surfaces, which would allow a pallet 100 to slide on or off the mobile robot 10.

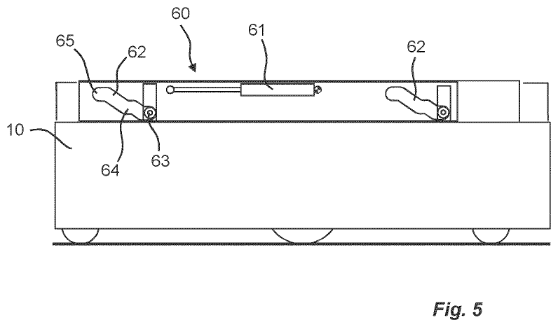

Now turning to FIG. 5 an embodiment is shown allowing improved control of the positioning of an associated pallet. As described above the arrangement is selectively configured in a first mode, allowing a pallet to slide on and off the arrangement by means of the sliding mechanism, a second mode, allowing a pallet to be stationary on the arrangement by resting on the fixed surface, and a third mode, allowing a pallet to be loaded on and off a pallet rack. Preferably, the pallet is arranged at three different vertical levels in the first, second, and third mode respectively by adjusting the vertical level of the sliding mechanism and/or the fixed surface.

In FIG. 5 the lifting mechanism 60 is shown which allows the vertical raising and lowering of the pallet relative the mobile robot 10. The sliding mechanism 60 comprises an actuator 61 and at least one tilted track 62 which is used to create a vertical motion of the bars 34 from a horizontal movement of the actuator 61. In FIG. 5 the bars 34 are positioned in their lowermost position, which is caused by the control of the actuator 61 such that the guiding rollers 63 of the bars 34 are arranged at the bottom end of the tracks 62. In this position, a loaded pallet will rest on the sliding mechanism.

When the pallet is to be transported, i.e. when the mobile robot 10 is about to start moving, the actuator 61 drives the bars 34 upwards such that the guiding rollers 63 rest on the intermediate plateau 64 of the tracks 62. In this position the pallet is raised such that it is arranged slightly above the sliding mechanism 60, and thus the pallet rests securely on the fixed surface 50 of the bars 34.

When the pallet is to be unloaded onto a pallet rack the actuator 61 causes the bars 34 to move further upwards such that the guiding rollers 63 rest on the uppermost plateau 65 of the tracks 62.

For all embodiments described above, the maximum vertical movement of the pallet 100 is typically between 20 and 100 mm, such as between 50 and 60 mm. This normally allows a pallet to be loaded and unloaded from a pallet rack. For ensuring safe transport the vertical movement may be in the range of 2-5 mm, sufficient to lift the pallet from the sliding mechanism but still allowing the sliding mechanism 60 to support the pallet if it starts to wiggle during transport.

1. An arrangement for a mobile robot, said arrangement forming an interface for a pallet to be loaded and unloaded from the mobile robot, wherein said arrangement comprises a sliding mechanism that forms a sliding interface for an associated pallet and a fixed surface that forms a stationary interface for the associated pallet, wherein the sliding mechanism and the fixed surface define respective first and second vertical levels, and wherein at least one vertical level is adjustable to an extent allowing an associated pallet to be loaded and/or unloaded from an associated pallet rack.

2. An arrangement for a mobile robot, said arrangement forming an interface for a pallet to be loaded and unloaded from the mobile robot, wherein said arrangement comprises a sliding mechanism that forms a sliding interface for an associated pallet and a fixed surface that forms a stationary interface for the associated pallet, wherein the arrangement is selectively configured in a first mode, allowing a pallet to slide on and off the arrangement by means of the sliding mechanism, a second mode, allowing a pallet to be stationary on the arrangement by resting on the fixed surface, and a third mode, allowing a pallet to be loaded on and off a pallet rack.

3. The arrangement according to claim 2, wherein the pallet is arranged at three different vertical levels in the first, second, and third mode respectively by adjusting the vertical level of the sliding mechanism and/or the fixed surface.

4. The arrangement according to claim 1, further comprising a control unit configured to selectively cause at least one of the sliding mechanism and the fixed surface to be arranged in an active position in which it is intended to be engaged with a loaded pallet.

5. The arrangement according to claim 4, wherein the control unit is configured to cause one of the sliding mechanism and the fixed surface to be arranged in the active position by vertically moving the sliding mechanism or the fixed surface.

6. The arrangement according to claim 5, further comprising a lifting mechanism being configured to vertically move the sliding mechanism or the fixed surface.

7. The arrangement according to claim 1, further comprising a base level surface and at least one elongated bar vertically displaced from the base level surface, wherein the base level surface and the at least one elongated bar comprises a respective one of the sliding mechanism and the fixed surface.

8. The arrangement according to claim 7, wherein the base level surface comprises the sliding mechanism, and the at least one elongated bar comprises the fixed surface, and wherein the at least one elongated bar is vertically moveable between a lowered inactive position, in which an associated pallet is engaged with the sliding mechanism at the first vertical level, and a raised active position, in which an associated pallet is engaged with the fixed surface at the second vertical level.

9. The arrangement according to claim 7, wherein the base level surface comprises the fixed surface, and the at least one elongated bar comprises the sliding mechanism, and wherein the at least one elongated bar is vertically moveable between a lowered inactive position, in which an associated pallet is engaged with the fixed surface at the first vertical level, and a raised active position, in which an associated pallet is engaged with the sliding mechanism at the second vertical level.

10. The arrangement according to claim 1, wherein the sliding mechanism comprises a drive unit for actively driving an associated pallet along the arrangement.

11. The arrangement according to claim 1, further comprising at least one sensor configured to monitor the position of an associated pallet being loaded onto the arrangement.

12. A mobile robot, comprising an arrangement according to claim 1.
